(19) United States
(12) Patent Application Publication
(10) Pub. No.: US 2007/0267061 A1
(43) Pub. Date: Nov. 22, 2007

(54) Volume-Displacing Device In Containers, Especially Tanks In Lpg Ships, And A Method Of Using Same

(76) Inventor: Ola Ravndal, Sandnes (NO)

Correspondence Address: PATENTS+TMS, P.C., 2849 W. ARMITAGE AVE., CHICAGO, IL, 60647, US

(21) Appl. No.: 11/663,022

(22) PCT Filed: Sep. 16, 2005
(86) PCT No.: PCT/NO05/00341

§ 371 Date: Mar. 15, 2007

(30) Foreign Application Priority Data
Sep. 21, 2004 (NO) 20043956

(51) Int. Cl. B08B 5/00

(52) U.S. Cl. 137/15.04

(57) ABSTRACT

The present invention discloses a bellows (5) for use in a fluid container (1), wherein the fluid container (1) is arranged so as to contain a first fluid comprising a liquid phase (7′) and a gas phase (7″), and wherein the bellows (5) is arranged so as to separate said first fluid (7′, 7″) from a second fluid (9) transported into the bellows (5) from the exterior of the container (1). In a preferred embodiment, the bellows (5), when filled, is arranged so as to occupy a volume portion of the second fluid (9) and, when emptied, is arranged so as to contain substantially no volume portion of said second fluid (9). The invention also concerns a method related to transport and/or discharging of a container (1), wherein the volume of said first fluid (7′, I1′) of the container (1) is replaced by a second fluid (9) filled into the bellows (5).

The present invention concerns a volume-displacing device in containers, especially tanks in LPG (Liquefied Petroleum Gas) ships. More particularly, it concerns a bellows or balloon arranged so as to separate a first fluid in a container from a second fluid transported into the bellows from the exterior of the container. The invention also concerns a method of using the invention.

In this document, the term container is used for a device suitable to contain a pressurized fluid.

The object of the invention is to reduce free space above a liquid level in a container exemplified by, but not limited to, a cargo tank in an LPG ship, thereby reducing the container volume that must be cleaned in connection with a cargo switch from a first cargo to a second cargo, wherein said second cargo chemically is not compatible with said first cargo, and thereby also reducing evaporation of the liquid phase of a fluid transported in the container.

In a container for petrochemical products, for example a cargo tank onboard on an LPG tanker, gas will be displaced from the cargo tank during filling, when liquid is supplied (for example the liquid phase of a gas). The gas being displaced oftentimes is toxic and must be handled in a proper manner in order to avoid environmental pollution in areas where loading and unloading is carried out. Typically, this is handled by allowing the cargo terminal to receive the displaced tank atmosphere when loading the tank.

Relatively frequently, a second and new cargo to be supplied to a container is not chemically compatible with a first and preceding cargo. In such situations, having unloaded or discharged the first cargo, and before filling the second cargo, the container must be subjected to extensive venting and cleaning, which is termed “purging” in the art, in order not to contaminate the second cargo filled into the container with product residues from the first cargo.

In situations where the second cargo is not chemically compatible with the first cargo, the following known and comprehensive cleaning procedure must be carried out:

After having substantially emptied the container, the container is heated up in order to evaporate and discharge a potential residual liquid phase from the first cargo;

the container is vented (“purged”) with an inert gas, which is a neutral gas that does not react with any other compounds, having a volume corresponding to several times the total volume of the container;

in those situations where visual inspection is to be conducted, the container must be further vented with atmospheric air, the container environment thus allowing for safe admission of inspection personnel. The ventilation is carried out with a volume atmospheric air corresponding to several times the total volume of the container;

after having conducted a potential visual inspection, the container must be vented again with an inert gas in an amount corresponding to several times the total volume of the container; and

the container then is cooled down, and the inert gas is replaced by the prevailing gas phase of the next cargo in order to avoid contamination from inert gas and/or air. This step is termed “gassing up” in the art.

There are several disadvantages related to the procedure according to the above-mentioned prior art. The main disadvantage is related to the large volumes of inert gas and air required during purging. Depending on the size of the tank, the procedure according to prior art may have a duration exceeding 72 hours for an LPG tanker. During this long period, the ship is inactive and in a form of “quarantine” in which the ship normally is not allowed to stay at quay at the terminal. In some instances, this results in a choice being made for the ship to leave the terminal and instead combining the transit time with a so-called ballast voyage prior to the next cargo loading. In addition to negative commercial aspects, this also involves a negative environmental aspect owing to the pollution generated by the combustion engine of a ship.

During transport of a fluid comprised by a liquid phase and a gas phase, which is the case for LPG, most of the container volume will normally be occupied by fluid in liquid phase. A portion of the fluid, however, will always be comprised of a gas phase located above the liquid phase when the tank is in its position of use. During transport of LPG according to prior art, some of the liquid phase will evaporate and enter into gas phase. This is termed an “evaporation product” in the art. After discharging or unloading, the evaporation product represents a negative environmental aspect and also negative commercial aspects, insofar as the evaporation product is vented out of the container during change of cargo.

The object of the invention is to remedy or at least reduce one or more disadvantages of prior art.

The object is achieved through features disclosed in the description below and in the subsequent claims.

In one aspect, the present invention is comprised of a bellows for use within a fluid container, wherein the fluid container is arranged so as to contain a first fluid present in a liquid state and/or a gas state, and wherein the bellows is arranged so as to separate said first fluid from a second fluid transported into the bellows from the exterior of the container. In a preferred embodiment, the bellows, when filled, is arranged so as to occupy a substantial volume portion of the second fluid and, when emptied, is arranged so as to contain substantially no volume portion of said second fluid. When filled, said volume portion in some cases may be substantially equal to the total volume of the container, and in a preferred state it may be in the order of ca. 75-100% of the total volume of the container. This causes the volume requiring purging between discharging a first cargo and loading of a second cargo, in which said cargos are chemically incompatible, to be reduced and confined to the annulus defined by an internal surface of the container and an external surface of the bellows filled with the second fluid.

In a preferred embodiment, said second fluid is comprised of an inert gas.

During transport of a fluid existing in a liquid phase and a gas phase in a container, a bellows according to the present invention is arranged so as to reduce the volume available for the fluid existing in the gas phase. By filling the bellows with a fluid until pressure balance is achieved, evaporation from the liquid phase will diminish considerably during unloading and will thus reduce the environmental and commercial consequences, as mentioned hereinbefore. For example, and not restricted thereto, said second fluid filled into the bellows may be an inert gas.

In a preferred embodiment, the bellows may be comprised of a polymer material suitable for use with the fluid in question.

The invention also concerns a method related to discharging a container containing a first fluid present in a liquid state and a gas state, wherein a volume portion of said first fluid of the container is replaced by a second fluid filled into a bellows disposed within said container.

In a preferred method, the bellows is filled with the second fluid at a volume rate substantially corresponding to the volume rate at which the liquid phase of said first fluid is removed during unloading. In an alternative method, the bellows is filled with the second fluid not until after some of, or substantially all of, a liquid phase of said first fluid is conveyed out of the container.

In the following, a non-limiting example of a preferred embodiment is described and depicted in the accompanying drawings, in which:

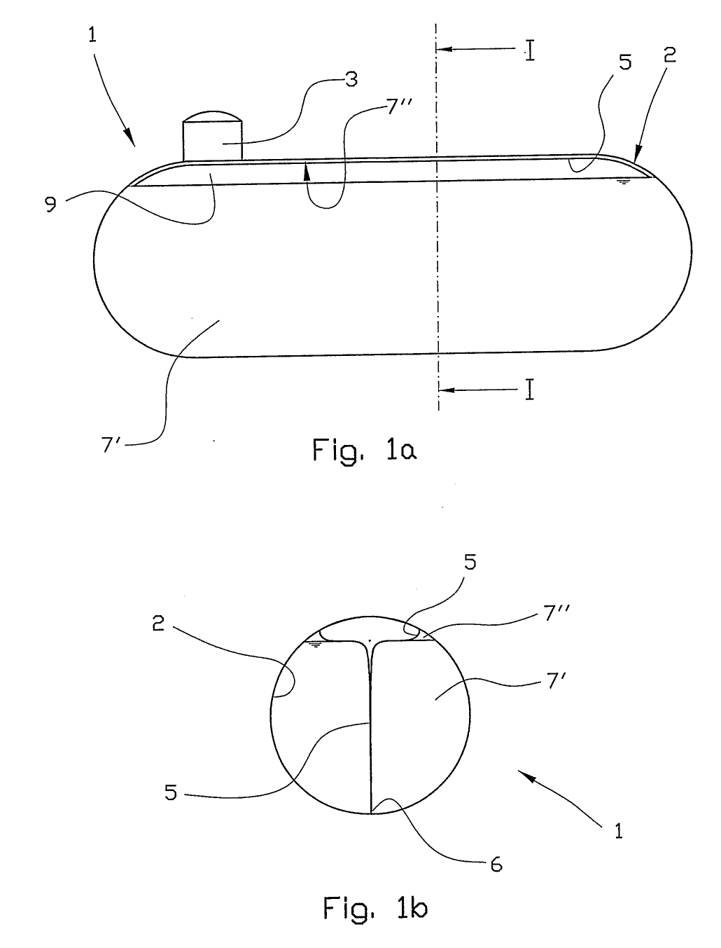

FIG. 1a shows a principle drawing of a container according to the present invention, in which the container is provided with an internal bellows filled with a fluid only in a top portion of the container;

FIG. 1b shows a section I-I through the container of FIG. 1a;

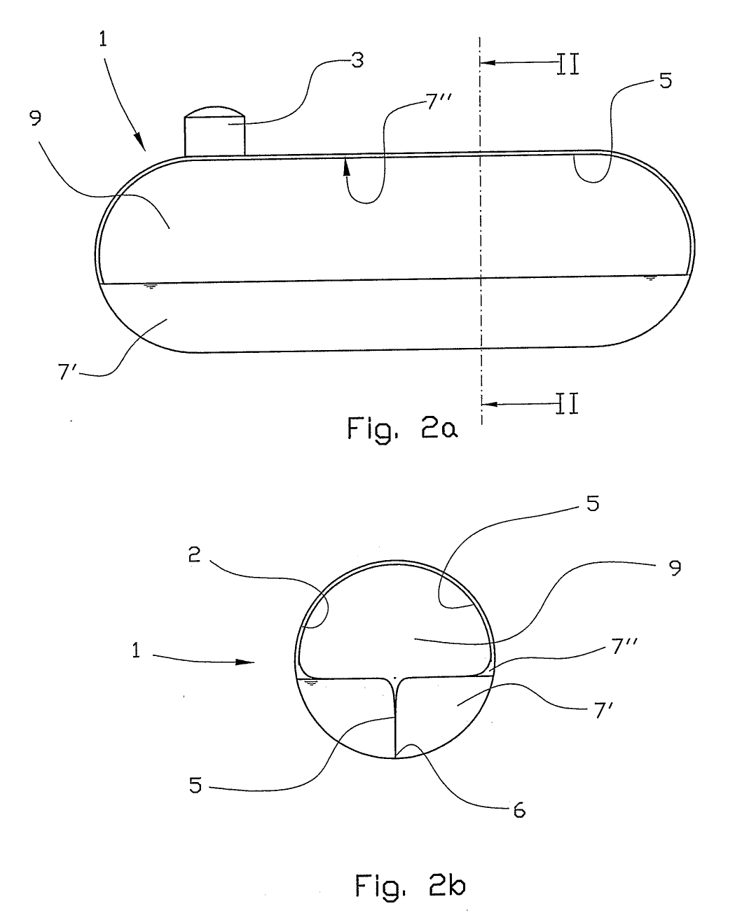

FIG. 2a shows the container of FIG. 1a as the bellows is filled with a fluid comprising, in volume, approximately 60% of the total volume of the container;

FIG. 2b shows a section II-II through the container of FIG. 2a;

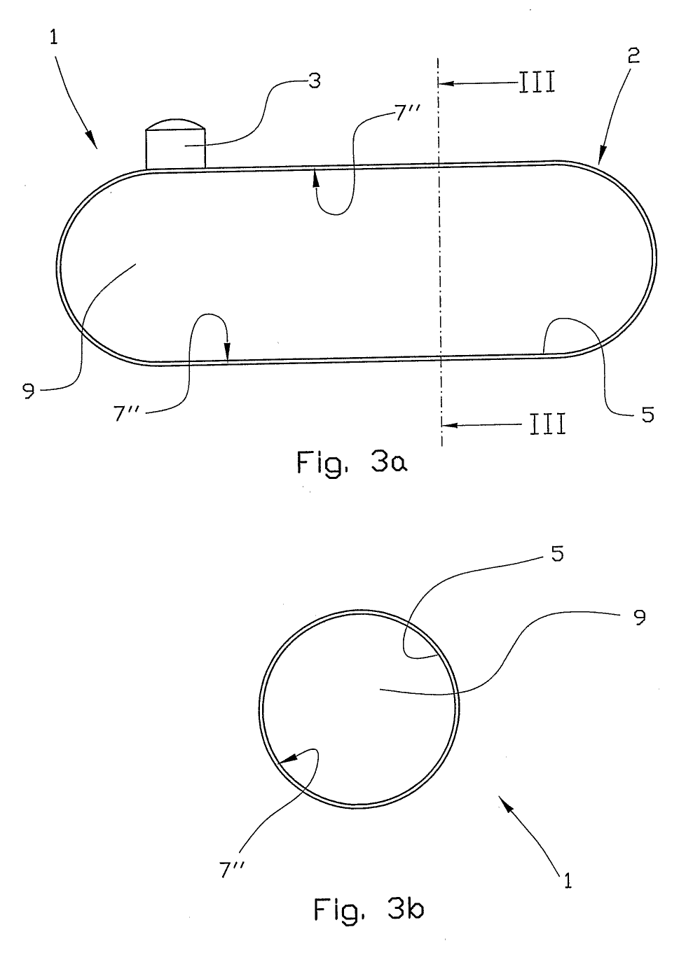

FIG. 3a shows the container of FIG. 1a, but in which the bellows is filled with a volume substantially corresponding to the internal volume of the container; and

FIG. 3b shows a section III-III through the container of FIG. 3a.

In the figures, reference numeral 1 denotes a container provided with a bellows 5 disposed within the container 1. For the sake of clarity, the container is shown having a manhole 3 only. A person skilled in the art will understand that a container for storing of fluids also must be provided with a number of connection points for apparatuses required to operate the container.

In FIGS. 1a and 1b, the container 1 is shown filled with a first fluid 7′, 7″, and the bellows 5 filled with a second fluid 9. The first fluid is comprised of a liquid phase 7′ and a gas phase 7″, in which the volume portion of the liquid phase 7′ comprises the main portion of said first volume. As best shown in FIG. 1b, the bellows 5 is filled with an amount of the second fluid, said amount occupying large parts of the volume that otherwise, i.e. without the bellows 5, would have been filled with gas phase 7″ of the first fluid 7. As a result of the natural characteristics of the bellows 5, the bellows 5 is in pressure balance whilst positioned above the liquid phase 7′ of the first fluid 7. In a transport situation, this results in considerably reduced evaporation from the liquid phase 7′. As mentioned hereinbefore, this has positive environmental and commercial effects.

In FIGS. 2a and 2b, the container 1 is shown in an embodiment in which the container 1 is filled only partially with the first fluid 7′, 7″, and in which the bellows 5 is filled with a second fluid 9. The figures illustrate a typical situation while emptying the container 1, in which the bellows 5 is filled with the second fluid 9 at a volume rate substantially corresponding to the volume rate at which the said first fluid 7 is removed during unloading. Moreover, the figures may be illustrative of a transport situation in which the container 1 is filled only partially with the first fluid 7′, 7″, and in which the bellows 5 is used to displace the volume of the container 1 that otherwise, i.e. without the bellows 5, would have been occupied by the gas phase 7″ of the fluid.

In FIGS. 3a and 3b, the bellows 5 is filled with a fluid 9, the volume of which substantially corresponds to the internal volume of the container 1. The fluid is transported into and out of the bellows 5 through a valve device (not shown) known per se, and which projects outwardly through a recess in a portion of the mantle 2 of the container 1. In other embodiments not shown herein, the bellows 5 may be provided with two or more valve devices for fluid communication into and out of the bellows 5.

In FIGS. 1b and 2b, a lower portion of the bellows 5 is shown attached to a bellows attachment portion 6 in the mantle 2 of the container 1. The object of this is, among other things, to facilitate a correct filling of the bellows 5. Even though FIGS. 1b and 2b show a preferred embodiment of bellows attachment, the bellows 5 may be attached to the container 1 in other portions thereof, or it may be disposed freely movable in the container 1.

In a preferred method related to discharging, the first fluid 7′, 7″ leaving the container 1 is replaced substantially continuously by a second fluid 9 filled into the bellows 5. In alternative methods (not shown), the bellows 5 is filled with the second fluid 9 not until after parts of, or all of, the first fluid has been discharged from the container 1. Independent of which method is used, a bellows 5 that according to the present invention is filled with a fluid, will reduce the volume requiring venting in connection with a change from a first cargo to a second cargo not being compatible with said first cargo. As shown in principle in FIGS. 3a and 3b, the volume requiring venting or purging will be reduced to the annulus defined between an internal surface of the container 1 and an external surface of bellows 5, a volume that is considerably reduced relative to the total container volume requiring venting when using prior art techniques without the use of a bellows. Even though FIGS. 3a and 3b show a bellows 5 occupying substantially all of the internal volume of the container 1, a person skilled in the art will understand that said annulus between the container and the bellows may be larger than that shown in said figures.

The second fluid 9 that is filled into the bellows 5, for example an inert gas, does not become contaminated by external fluids. For this reason, the second fluid 9 may be re-used or be used for venting purposes in other containers (not shown).

Furthermore, the bellows 5 is suitable for keeping two liquids separated in one container. This, for example, may concern intermediate storage of ballast water to be processed in a purification plant, or it may concern intermediate storage of produced water.

1. A method related to a change of cargo of a transport vessel having at least one fluid container containing a first fluid comprising a liquid phase and a gas phase wherein a second fluid is introduced into a bellows wherein the bellows is situated inside the fluid container wherein an expansion of the bellows reduces an internal volume of the fluid container which is available for the gas phase, the method comprising the steps of:
a) ventilating the fluid container by filling the bellows with the second fluid such that an amount of the gas phase which is to be vented by an inert gas is limited to a volume defined by an internal surface of fluid container and the outer surface of the bellows; and
b) replacing the inert gas in the volume with the gas phase of the cargo.

2. The method of claim 1, further comprising the following steps between the steps a) and b):
ventilating the fluid container with atmospheric air;
emptying the bellows, at least partly, for the second fluid, preferably simultaneously with the ventilating of the fluid container with the atmospheric air wherein an environment in the fluid container allows safe entry for inspection personnel;
filling the bellows to occupy an increased proportion of the internal volume of the fluid container; and
ventilating the fluid container with an inert gas.

3. The method of claim 1 wherein the second fluid is introduced into the bellows as the liquid phase of the first fluid is discharged from the fluid container.

4. The method of claim 1 wherein the second fluid is introduced into the bellows at a point in time during a discharge of the liquid phase of the first fluid from the fluid container.

5. The method of claim 1 wherein the second fluid is introduced into the bellows after substantially all of the liquid phase of the first fluid is discharged from the fluid container.

6. The method of claim 1 wherein the second fluid is an inert gas.

7. The method of claim 1 further comprising the step of:
arranging the bellows wherein the remaining volume of the gas phase required to be removed from the fluid container in connection with a change of cargo from the first fluid to a subsequent second cargo is reduced.
